(19) United States
(12) Patent Application Publication
(10) Pub. No.: US 2003/0145770 A1
(43) Pub. Date: Aug. 7, 2003

(54) Apparatus for the sowing of seeds and planting of saplings

(76) Inventor: Matti Reinikainen, Vantaa (FI)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/258,424

(22) PCT Filed: Nov. 29, 2000
(86) PCT No.: PCT/FI00/01038

(30) Foreign Application Priority Data
Apr. 25, 2000 (FO) 20000967
May 19, 2000 (FI) US0000213

(51) Int. Cl. A01C 11/00

(52) U.S. Cl. 111/100

(57) ABSTRACT

An apparatus for the sowing of seeds and/or planting of seedlings, comprising a spot scarification device (22) having rotatable cutters for mixing and chaffing a spot of a predeterminded sized at a desired seeding or planting place from the biomass, such as humus and mineral earth, in the ground, and a planting/seeding device (21) comprising a vertically movable planting/seedling part for the sowing of seeds and/or planting of seedlings. Using the apparatus of the invention, the seeds can be sown and the seedlings planted saving labor, time as well as seeds and seedlings and without stressing the soil in the area. In addition, the seeds can be sown and the seedlings planted in conjunction with felling and/or harvesting.

The present invention relates to an apparatus for the sowing of seeds and planting of seedlings.

In the maintenance, renewal, restoration or landscaping of a forest, park or other area, seeds of desired plants are sown or seedlings are planted in the area. In renewal by cultivation, the seeds are sown and/or the seedlings are planted in the area to be renewed after timber felling and harvesting At present, intensive tillage methods such as plowing, harrowing or mounding are used to create good conditions for the germination and growth of seeds and seedlings.

A problem with previously known methods is that renewal performed after timber felling and/or harvesting is a separate operation requiring separate labor and time. In addition, prior-art methods require tillage that disrupts the area, or they often involve too intensive tillage, promoting the propagation of plant diseases, among other things. Moreover, in many cases those methods produce undesirable changes in the landscape. Further, the cultivation methods accelerate grass overgrowth in the renewal area. These methods may also remove a part of the thermal insulation of the soil surface, such as moss and dry peat, with the result that frost, especially after rain, causes freezing of the soil surface, which is destructive to seedlings.

On the other hand, in untilled soil the beginning of growth of plants is by far slower than in tilled soil. In untilled soil, for example the germination and sprouting of seeds is slow and a proportion of the seeds are never activated into growth. Therefore, the area under renewal has to be renewed over and over again, and excessive quantities of seeds are used to ensure a successful renewal.

The results of renewal by current methods is not natural in respect of landscape or ecological aspects.

The object of the present invention is to eliminate the problems described above and to achieve an apparatus for the maintenance, renewal, restoration or landscaping of an area that maintains and/or enhances the biological diversity of the area. A specific object of the invention is to achieve an apparatus for renewing and restoring forests so as to form natural, commercial, special and/or park forests.

With the apparatus of the invention for the sowing of seeds and planting of seedlings, a spot of a certain size is scarified in the place of sowing or planting and the biomass, humus and mineral mass in that place are mixed. The details of the features of the apparatus of the invention are presented in the claims below.

Using the apparatus of the invention, the seeds can be sown and the seedlings planted saving labor, time as well as seeds and seedlings and without stressing the soil in the area. In addition, the seeds can be sown and the seedlings planted in conjunction with felling and/or harvesting.

In a preferred embodiment of the invention, it is possible to utilize the method presented in Finnish patent specification FI 100725, in which samples are taken from the soil in the area under cultivation and, based on these, microbial growth in the area is determined and in which the condition of the area is estimated on the basis of the microbial growth and, by using a model file as presented in the patent specification referred to, the growth results obtained can be used in the control of sowing and planting.

Thus, using the apparatus of the invention, it is possible e.g. to sow seeds of one or more plant species at the same time. By sowing seeds of different species, the known succession development of the forest can be accelerated. The seeds to be used are selected from among seeds of conifers, broadleaf trees, shrubs, graminids and/or corresponding plants according to the intended use. Seeds of shrubs and graminids are used along with seeds of the dominating wood species to increase diversity in the renewal areas. In forest renewal, seeds of conifers, such as fir and/or pine, are normally used, and in mixed forests additionally seeds of broadleaf trees, e.g. birch, are used. Seeds of noble broadleaf trees can be used in grove type forests. The seeds are preferably selected from among seeds of symbiotic plants. In tropical areas, seeds of e.g. rain forest trees and plants are used, e.g. seeds of eucalyptus trees. Seeds of fast growing graminids, e.g. hays, grasses, willow herb, etc., can be in used in a controlled manner together with seeds of trees to protect the seedlings of trees.

Seeds of broadleaf trees, e.g. birch, alder, aspen, mountain ash, goat willow etc., which grow faster than conifers, are also used to protect the seeds and/or seedlings of other trees and to prevent grass overgrowth and to increase or vary the diversity and to promote healthy conditions in the soil. By sowing seeds of different plant species, renewal can be accomplished without the use of plant-protecting agents. The seeds of plants producing different nutrients can also be used to produce nutrients for the seeds/seedlings of other species; for example, alder seeds/seedlings can be used to produce nitrogen in the soil.

The seeds and seedlings can be sown on the area to be renewed, restored and/or equivalent using e.g. a harvester by coupling it to an apparatus according to the invention. The seeds and seedlings can be sown on the forest area in conjunction with felling and/or harvesting, thus obviating the need for laborious and expensive renewal afterwards.

In the following, the invention will be described in detail by the aid of an example with reference to the attached drawings, wherein

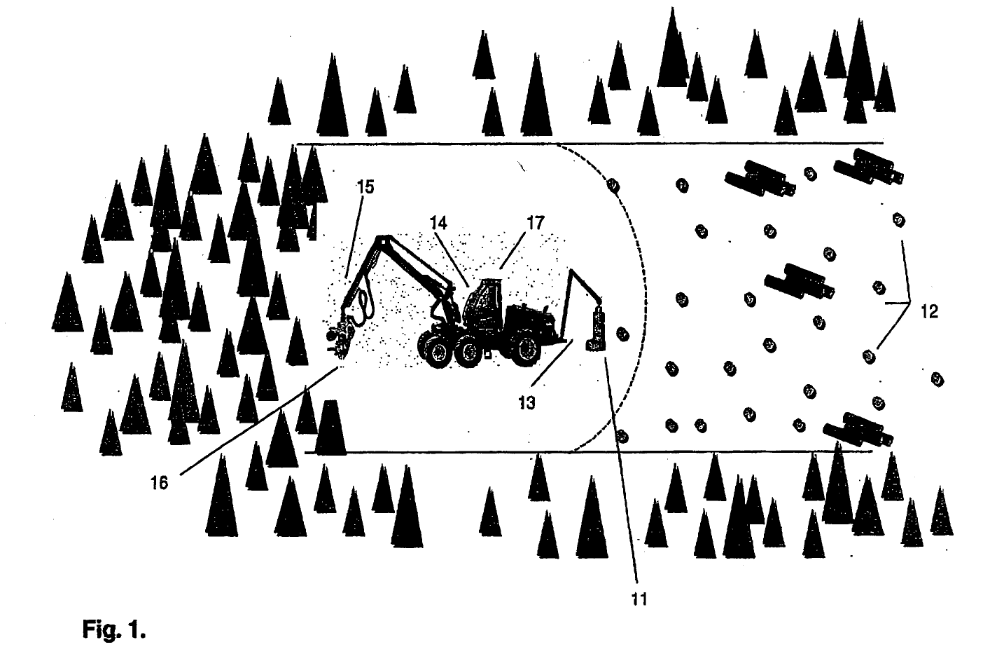

FIG. 1 presents an apparatus according to the invention in a forest renewal situation as described above, and

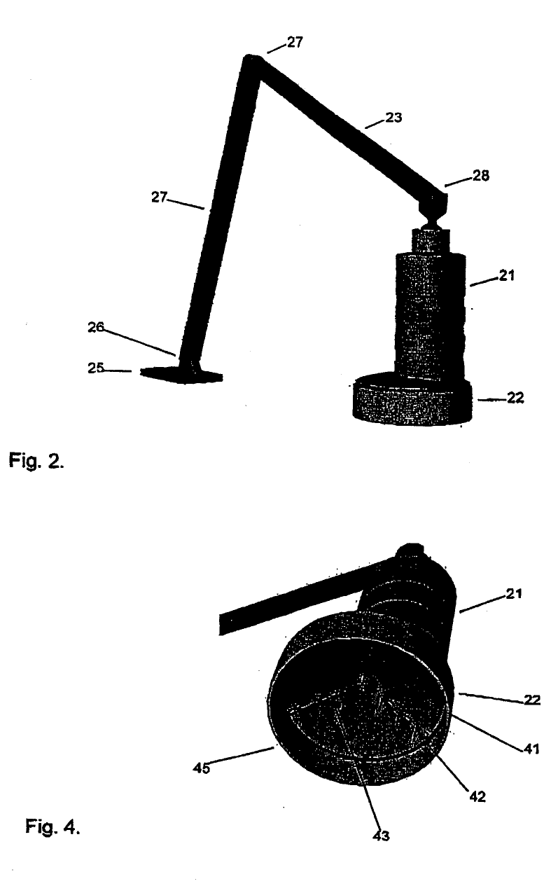

FIGS. 2-6 present a spot scarification/seeding device in side view, in a partly sectioned view, in bottom view, in a view showing the seed tube and in a view showing the stone detector, and

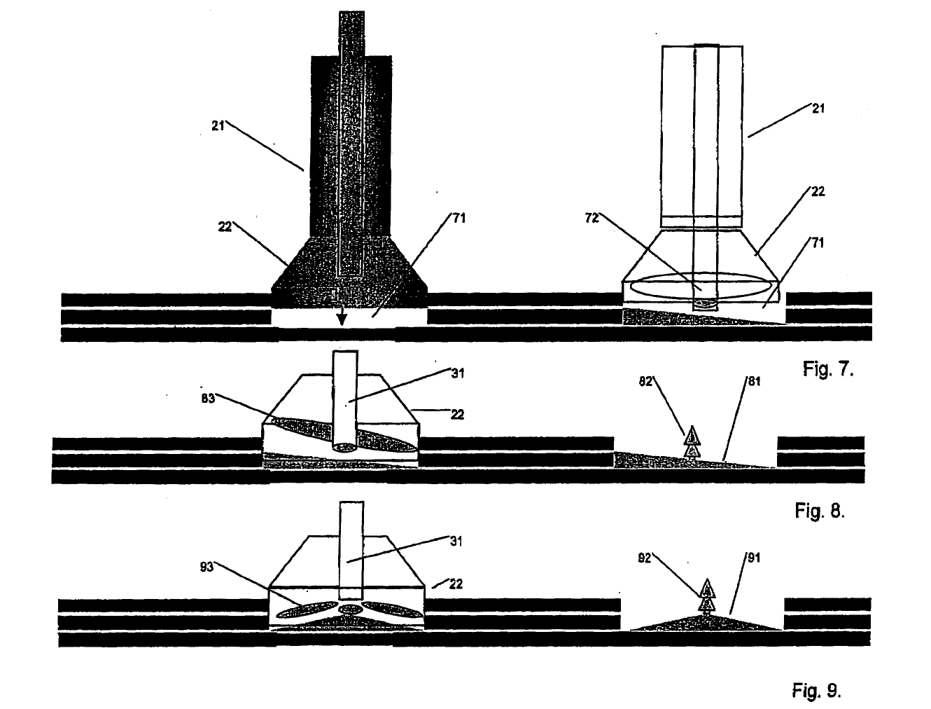

FIGS. 7-9 illustrate the sowing of seeds and planting of seedlings using the apparatus of the invention.

FIG. 1 presents a spot scarification/seeding apparatus 11 according to the invention for the sowing of seeds and planting of seedlings, by means of which a spot 12 of a certain size is scarified at the seeding or planting place and the biomass, humus and mineral mass at the seeding or planting place are mixed. The apparatus of the invention 11 can be coupled by means of an articulated arm 13 to a machine, e.g. a forest harvester 14, which is provided with a harvester head 15 providing the operating power. The width of the forest renewal sector 16 corresponds to the working sector of the harvester.

Structure of the Apparatus

FIGS. 2-6 present more detailed illustrations of the apparatus. FIG. 2 presents a spot scarification/seeding apparatus, which comprises a cylindrical seeder 21 for the sowing of seeds and a spot scarification funnel 22 below it, by means of which a spot 12 of a certain size is scarified at the seeding or planting place and the biomass, humus and mineral mass at the seeding or planting place are mixed. The arm structure connecting the apparatus to the harvester consists of two arm sections 23. 24, a mounting plate 25 to be fixed to the harvester, and hinge joints 26-28 connecting the arm sections to each other, one of the hinge joints connecting the arm structure to the harvester and another one to the spot scarification/seeding apparatus.

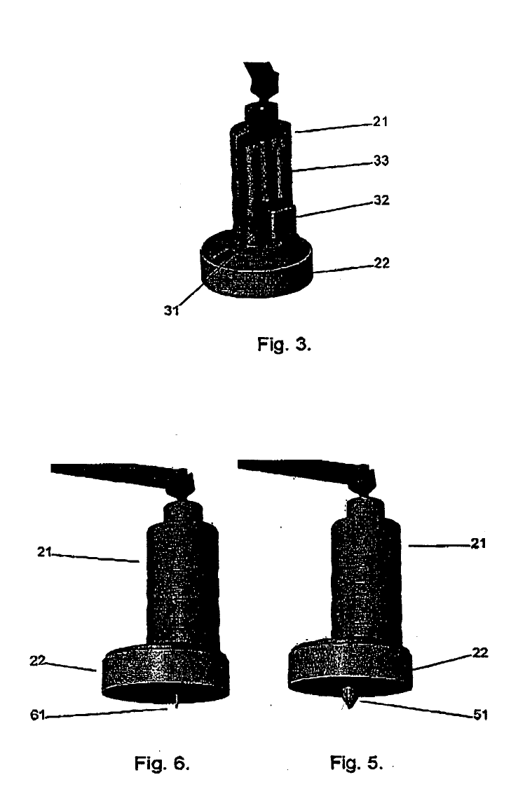

FIG. 3 presents a partially sectioned view of the spot scarification/seeding apparatus, Inside the cylindrical seeder there is a planting/seeding tube 31 which is moved in the vertical direction by a drive 32, the seeds being sown into the soil from the lower end 51 (FIG. 5) of the tube. In addition, placed inside the seeder are cylindrical containers (cartridges) 33, in which seeds can be placed e.g. in round seed cushions on top of each other. The cartridges 33 can be rotated by the drive 32 along a circular path so that a desired cartridge can be brought to the position above the planting tube, thus making at possible to select the seeds to be sown as well as the order in which they are to be sown, the operation being controlled by a control system as described below.

FIG. 4 presents a spot scarification funnel 22, by means of which the biomass, humus and mineral mass at the seeding or planting spot are mixed, It comprises a rotatable, plate-like cutter holding frame 41, which is rotated by the drive 32, and spring-like cutter wires 42 attached to it, these being turnably mounted on shafts 43 so that they will not be damaged by stones or the like. For the detection of stones or the like, the spot scarification funnel may additionally be provided with a sensor 61 to prevent the seed tube 51 from being lowered onto a stone or the like.

The apparatus can be controlled via a control computer 17 mounted on the harvester 14 and connected to the drive 32. In the control, a model file according to Finnish patent specification 100725 stored in the memory of the control computer 17 is utilized. It contains growth descriptions of microbes and microbial groups for the comparison of growing samples. It is also provided with a set of instructions for the estimation of the condition of the area. Thus it is possible e.g. to select a suitable microbial population for infecting the roots of the seedlings before they are planted in order to create a seedling stand suited to the area. It is also possible to choose a suitable selection of seeds of different plants, which are placed in different cartridges 33, and to control the drive 32 so that it will deliver them in a desired order. The seeds can be arranged e.g. in a predetermined manner so that different seeds are distributed over the seeding area in a desired manner,

Operation of the Apparatus

The cutters 42 under the spot scarification funnel 22 are rotated by the drive 32, scarifying a spot 71, 81, 91 at the place where a seed is to be sown or a seedling to be planted (FIGS. 7, 8, 9). The size of the spot can be varied by changing the spot scarification funnel 22. The replacement funnel sizes are e.g. 20, 40, 60 and 80 cm in diameter. The spot scarification funnel can be changed with help of quick-release straps around the seeder 21. The shape of the cutter holding frame 83, 93 can also be varied so as to allow the spot 81, 91 to be shaped as illustrated in FIGS. 7, 8, 9 to give It e.g. an inclined or mound-like shape. At the same time, it is possible to change the cartridges 33 and clean the whole apparatus.

The spot scarification funnel 22 is provided with a protective collar 45 (FIG. 4) to prevent the material loosened by the cutters from being hurled out around the intended spot As a result of the rotation of the device and the cutting action of the cutters, a scarified spot 71, 81, 91 of a controlled size is produced that is propitious for the start of growth of the seed or seedling. Into the spot thus prepared, a seed on a seed cushion 72 or a seedling 82, 92 is brought via the planting/seeding tube 31. The seed tube 31 is located at the center of the spot scarification funnel. The planting/seeding tube rotates and cuts a hole suitable e.g. for the planting of a pot seedling. The seedlings 82, 92 can be passed into the tube via a separate “dropper” placed at its upper end.

The seeds and seedlings to be sown are selected in the manner described above as directed by the control computer 17 and the model file contained in it.

It is obvious to the person skilled in the art that different embodiments of the invention are not restricted to the examples described above, but that they can be varied within the scope of the following claims.

1. Apparatus for the sowing of seeds and/or planting of seedlings, comprising:
a control unit (1),
a spot scarification device (22) having rotatable cutters (42) for mixing and chaffing a spot (12, 71, 81, 91) of a predetermined size at a desired seeding or planting place from the biomass, such as humus and mineral earth, in the ground, and
a planting/seeding device (21), comprising a vertically movable planting/seeding part (31) for the sowing of seeds and/or planting of seedlings (82, 92),
characterized in that the control unit (1) selects a suitable microbial population for infecting the seeds and/or the roots of the seedlings before the seeding/planting, and/or a suitable selection of seeds and/or seedlings of different plants so that different seeds/seedlings are distributed over the sowing area in a desired manner.

2. Apparatus as defined in claim 1, characterized in that the planting/seeding device (21) is fitted in conjunction with the spot scarification device (22).

3. Apparatus as defined in claim 1, characterized in that the planting/seeding device is a seeding/planting tube (31) for placing a seed or seedling in a scarified spot.

4. Apparatus as defined in claim 1, characterized in that the cutters are fitted in a cutter holding frame in the spot scarification funnel (22), and that the size and/or shape of the cutters and/or frame can be changed in order to change the shape and/or size of the scarified spot.

5. Apparatus as defined in claim 1, characterized in that the apparatus can be coupled to a machine, such as a forest harvester (14), from which the operating power for the apparatus can be obtained from the machine, such as a forest harvester (1.2), to which the apparatus (1.1) is coupled.

6. Apparatus as defined in claim 1, characterized in that the apparatus can be controlled by means of a control unit (1) connected to the drive (32) of the apparatus.

7. Apparatus as defined in claim 6, characterized In that the control is implemented using a model file stored in memory and containing growth descriptions of microbes and microbial groups for the comparison of growing samples, said file being provided with a set of instructions for the estimation of the condition of the area.

8. Apparatus as defined in claim 3, characterized in that the seeds/seedlings are fitted in containers (33) of a preferably cylindrical form which can be moved in relation to the seeding/planting tube (31) so as to allow the selection of a desired container.
